(19) United States
(12) Patent Application Publication
(10) Pub. No.: US 2006/0237371 A1
(43) Pub. Date: Oct. 26, 2006

(54) Sorbent for selective removal of contaminants from fluids

(76) Inventors: Paul Sylvester, Waltham, MA (US); Owen E. Boyd, Holliston, MA (US)

Correspondence Address: WOOD, HERRON & EVANS, LLP, 2700 CAREW TOWER, 441 VINE STREET, CINCINNATI, OH, 45202, US

(21) Appl. No.: 11/114,717

(22) Filed: Apr. 26, 2005

(51) Int. Cl. C02F 1/42

(52) U.S. Cl. 210/684

(57) ABSTRACT

Metal oxide modified or impregnated fibers as a sorbent to reduce contaminants such as arsenic from a fluid stream. The kinetics of the sorbent enable it for point of use or point of entry applications, including but not limited to household treatment of drinking water.

### FIELD OF THE INVENTION

The invention relates to use of a sorbent to remove contaminants from fluids such as drinking water.

### SUMMARY OF THE INVENTION

One embodiment of the invention is a polymeric anion exchange fiber or fibrous sorbent that contains particles of a hydrated metal oxide dispersed throughout the fibers, the sorbent removing one or more contaminants from the fluid. The fibrous sorbent may have a polyolefin, polystyrene, polyacrylic, viscose, or other polymer backbone, with a positively charged functional group, such as a quaternary amine group, a quaternary pyridinium group, or a similar group.

Another embodiment is a method for selectively removing at least one contaminant from a fluid stream (e.g., drinking water, industrial water) by contacting the fluid stream with the previously described sorbent for a time sufficiently short to allow point of use or point of entry contaminant removal or reduction. This contaminant removal rate exceeds the rate when the fluid stream is in contact with an anion-exchange resin bead sorbent. The contaminant(s) removed by the sorbent may include arsenate, arsenite, dichromate, chromate, molybdate, selenite, uranium, vanadate, copper, zinc, antimony, molybdenum, tungsten, barium, and/or radium.

Another embodiment is a method for reducing a contaminant from a fluid stream using a hydrous or hydrated iron oxide (HFO) impregnated anion exchange fiber or fibrous sorbent, contacting a portion of the sorbent with the fluid stream for half a minute or less, thus obtaining a treated fluid stream having a reduced contaminant level. The method is economical, operationally simple, requires virtually no start-up time, and is forgiving toward fluctuations in feed compositions. The HFO-impregnated anion exchange material, or sorbent, is durable, exhibits selectivity toward the target contaminant(s), and is amenable to efficient regeneration and reuse. Removing the target contaminant does not cause major changes in pH or in the composition of the influent water.

Another embodiment is a method of polishing a fluid stream already treated to reduce a level of at least one contaminant by further contacting the fluid stream with the previously described sorbent. The fluid stream may have a variable flow rate, e.g., industrial effluent.

The previously described sorbent may be contained in a filter. In this embodiment, it may be used in a drinking water container, a household purification system, a refrigerator line to dispense purified water and/or ice, etc.

These and other embodiments will be further appreciated with reference to the following drawings, description, and examples.

### BRIEF DESCRIPTION OF THE DRAWINGS

FIG. 1 is a graph showing performance of three different modified fibers and a resin bead in a simulated point of use test.

FIG. 2 is a graph showing results with one fiber type after drying.

FIG. 3 is a graph showing results with one fiber type with a 300 ppb arsenic influent.

### DETAILED DESCRIPTION

Anion exchange fibers or fibrous sorbents with particles of a hydrated metal oxide substantially dispersed therein are disclosed. These sorbents remove contaminants from fluid streams and have reaction kinetics that enable their location at a point of use (POU) or point of entry (POE) where contact times between the sorbent and fluid stream are typically fifteen seconds or less. The fibers exhibit excellent kinetics, hydraulic properties and durability during fixed bed column runs. The dispersed hydrated metal oxide or hydroxide particles serve as active sorbents for the target ligands. The metal may be Cu(I), Mn(II), V(III), Sn(II), Pt(II), Fe(II), Co(II) or Ru(II).

In one embodiment, an iron-hydroxide impregnated fiber anion-exchange sorbent, when used to remove contaminants from a fluid stream, exhibited reaction kinetics that exceeded those obtained when conventional ion exchange or other resin beads are used as the sorbent. Standard ion exchange rein beads usually require between two and five minutes of contact time with a fluid stream to be effective in removing a contaminant. At shorter contact times, their effectiveness is drastically reduced; ArsenX^{np} beads performed far poorer than the modified fibers. At a contact time of three minutes, the ArsenX^{np} beads would perform better than the fibers due to a higher iron content and hence a larger arsenic capacity, but this capacity cannot be utilized at high flow rates due to diffusion limitations. In one embodiment, iron hydroxide impregnated fibers for point of use or point of entry applications to reduce and/or remove contaminants from drinking water are disclosed.

A method of preparing metal hydroxide modified or impregnated fibers has been disclosed in U.S. patent application Ser. No. 10/925,600 to SenGupta, which is expressly incorporated by reference herein in its entirety.

An oxidizing anion such as persulfate, permanganate, hypochlorite, nitrate, nitrite, FeO₄²⁻, perchlorate, bromate, iodate, and/or chlorite, is contacted with an anion exchange fiber or fibrous sorbent. Then, a solution of a metal salt, such as ferrous (Fe(II)) salts or manganous (Mn(II)) salts, is contacted with the oxidized anion exchange sorbent, simultaneously desorbing the oxidizing anion from the fiber or fibrous sorbent, oxidizing the metal ion, and precipitating and dispersing hydrated metal oxide particles throughout the anion exchange fiber or fibrous material. This may be followed by washing using an organic solvent, and drying the modified sorbent.

Conventional ion exchange resin bead sorbents, including those previously described, require a contact time of several minutes with a fluid stream in order to effectively remove a contaminant. This contact time is required due to the relatively slow diffusion of contaminant(s) into active sites within the resin bead. However, when the sorbent of the present invention is to be placed at the point of use or point of entry, more rapid reaction kinetics between the sorbent and contaminant(s) are required. For sorbents used in point of use or point of entry applications, the desired level of decontamination is achieved in a shorter time, in the range of about fifteen seconds or less.

In one embodiment the inventive method is used in a household point of use or point of entry application. In this embodiment, the modified or impregnated fibers may be incorporated into a containment device to serve as a filter. The filter can be incorporated in a fluid stream that is connected to a refrigerator and/or freezer, such that filtered water may be used to make ice that is dispensed from the freezer and/or may be used to supply water that is dispensed from the refrigerator. A filter can be used in a water container, such as a pitcher, and may be an integral part of the pitcher or may be added as a separate component. A filter may be used in an individual filtration system, for example, it may be of a sufficiently small size to use as a countertop or under the sink component. Use in a household point of use or point of entry system permits small size design and minimal contact time versus that required by a conventional resin system. It may be connected to a single faucet or a plurality of faucets. The fibers may be incorporated into filter mats, spiral wound media, woven media, or non-woven media for water treatment.

In one embodiment the modified or impregnated fibers may be used to polish water that has been treated by a conventional sorbent system. This embodiment may be used where flow rates are variable, such that the inventive method used as a polisher is able to accommodate the relatively higher flow rates that are in excess of design specifications for conventional sorbents.

One example of such an embodiment is industrial applications, for example, a high-speed polisher for removing arsenic from drinking water at a municipal water authority. This allows a plant to be designed to accommodate an average water flow rate, as opposed to being designed to accommodate a maximum water flow. Conventional bead-form or granular sorbents are used for arsenic removal at average flow, but at maximum flow, some bleed of arsenic from the main bed will occur which will be removed by the fiber-based polisher. Thus, at normal flows, the polisher will not see any arsenic and thus the capacity will remain available to remove arsenic when required at maximum flow. The use of the polisher system will reduce capital expenditure and plant operating costs and will also decrease the footprint of the treatment plant.

The invention will be further appreciated with reference to the following examples.

### EXAMPLE 1

Three different samples of Smopex® synthetic polymer anion exchange fibers were provided by Smoptech (Turku, Finland). Smopex® is the trademark for synthetic fibers for the recovery of metals from waste solutions and solutions from industrial and commercial processing. The characteristics of the fibers are shown in the following table (Table 1).

| | Capacity | Moisture | Functional | Polymer |
|---|---|---|---|---|
| Identity | meq/g | Content % | group | Backbone |
| Smopex ®-103 | 2 | 7 | Quaternary | Polyolefin |
| | | | Amine | |
| Smopex ®-105 | 4 | 14 | Quaternary | Polyolefin |
| | | | Pyridinium | |
| DS-244 | 2 | 15 | Quaternary | Polyacrylic |
| | | | Amine | |

The fibers were used as received and 100 g of each material was impregnated, using iron as the metal, resulting in nanoparticles of hydrous iron oxide, and using permanganate as the anionic oxidant.

An amount of potassium permanganate (KMnO₄) equivalent to 105% of the stated anion exchange capacity was dissolved in two liters of deionized water. 100 g of one of the three Smopex® fibers was added and the mixture stirred for thirty minutes. The mixture was then filtered through a coarse filter paper under vacuum, and the solid was washed with deionized water until the majority of the residual permanganate was removed and the washings had only a faint pink color.

The permanganate-loaded fibers were added to a solution of ferrous sulfate heptahydrate (FeSO₄.7H₂O) dissolved in two liters of deionized water and allowed to stir for at least five hours. Sufficient ferrous sulfate was added to obtain a 4:1 molar ratio of iron to permanganate, assuming saturation of the anion exchange sites. After the reaction was completed, the iron solution was decanted and the fibers washed with a 0.5% NaCl/0.5% NaHCO₃ solution until the pH was >6 and the product was free from unassociated iron hydroxide floc. The fibers were then placed in a Buchner funnel and vacuum was applied at room temperature to remove surface moisture.

The following table (Table 2) summarizes the mass of permanganate and iron sulfate used in the syntheses.

| Fibers Identification | Mass of KMnO₄/g | Mass of FeSO₄.7H₂O/g |
|---|---|---|
| Smopex ®-103 | 33.2 | 222 |
| Smopex ®-105 | 66.4 | 444 |
| DS-244 | 33.2 | 222 |

Smopex®-103 and Smopex®-105 fibers, when added to permanganate, were hydrophobic and formed clumps on the surface of the permanganate solution. The clumps made it difficult to ensure all the fibers became modified or impregnated with permanganate. Prior to adding permanganate fibers to the iron solution, small amounts of unreacted fibers were noted among the loaded or impregnated fibers.

In contrast, synthesis was facilitated when DS-244 fibers were used. The DS-244 fibers were readily dispersed into the permanganate solution and appeared to be homogenously modified or impregnated with permanganate. The difference between DS-244 fibers and Smopex®-103 and Smopex®-105 fibers likely resulted from the more hydrophilic nature of the acrylic base polymer of DS-244, as opposed to the more hydrophobic polyolefin base of Smopex®-105 fibers.

Each sample of impregnated fibers was analyzed for moisture, iron (Fe), and manganese (Mn) content. Iron and manganese were determined by treating a 0.25 g sample with a 10% HCl/2% hydroxylamine sulfate solution to remove all iron and manganese from the fibers. Following an appropriate dilution, this solution was then analyzed for Fe and Mn by inductive coupled plasma/atomic emission spectroscopy (ICP/AES). The results are given the table below (Table 3), showing the composition of the iron-impregnated Smopex® fibers. Both iron and manganese contents are quoted per gram of dried fiber.

| Sample | Moisture % | mg Fe per dry g | Mn mg per dry g |
|---|---|---|---|
| Smopex ®-103 | 42.7 | 73 | 22 |
| Smopex ®-105 | 42.0 | 62 | 147 |
| DS-244 | 55.0 | 140 | 0 |

### EXAMPLE 2

A sorbent used in a point of use device must have rapid kinetics. Consequently, the Smopex® fibers were evaluated in a simple column with an Empty Bed Contact Time (EBCT) of about 12 seconds. This EBCT provided a sufficiently fast flow to mimic conditions likely to be encountered in typical household applications where a point of use device may be used.

An 8 mL column (standard ion exchange column with an internal diameter of 15 mm) of the modified fibers was used in all experiments. The flow rate was about five bed volumes (BV)/min, i.e. an empty bed contact time of 12 seconds. Synthetic water, spiked with 50 ppb arsenic (as arsenate) described below and composition given in the table below, at a pH of 6.5, was passed through the column and the volume was recorded. Samples were collected periodically and analyzed for their arsenic content using ICP/AES. Columns were run continuously for eight to ten hours during the day and turned off at night.

The approximate composition of the synthetic water is given below (Table 4). This water is an NSF “standard” water used for the majority of arsenic uptake tests to allow a direct comparison between materials.

| Component or Property | Concentration mg/L |
|---|---|
| Sodium | 153 |
| Calcium | 40 |
| Magnesium | 12 |
| SiO₂ | 20 |
| Fluoride | 0.8 |
| Chloride | >71 * |
| Sulfate | 47 |
| Phosphate | 0.1 |
| Nitrate | 9 |
| Carbonate/Bicarbonate | 180 |
| pH | 6.5 |

* pH adjusted using HCl, therefore 71 ppm was the minimum amount of chloride present

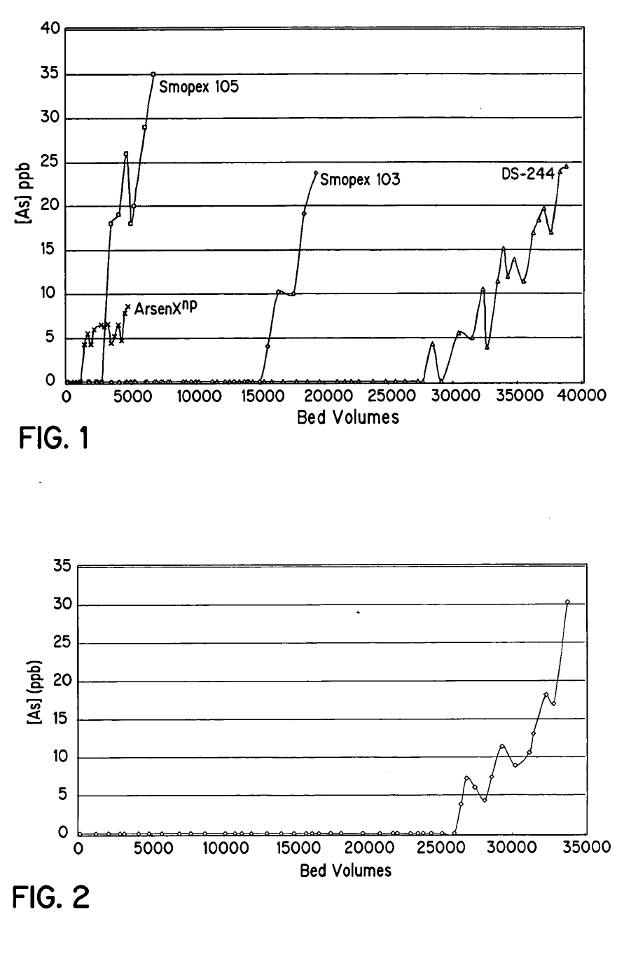

FIG. 1 shows the concentration of arsenic in the column effluent versus the bed volumes of water treated by hydrous iron oxide loaded DS-244, Smopex®-103 and Smopex®-105 fibers as sorbent. The DS-244 fiber sorbent, with a high iron content and relatively hydrophilic polymer backbone, removed more arsenic compared to either Smopex®-103 or Smopex®-105 fiber sorbents. The DS-244 fiber sorbent column lasted approximately 33,000 bed volumes (BVs) until 10 ppb arsenic breakthrough occurred, giving a loading of about 2.7 mg arsenic per gram of modified fiber. As a reference, a minimum performance of 5,000 BVs to 10 ppb breakthrough is required for a material to be considered for a point of use application. When breakthrough did occur, the concentration of arsenic in the effluent generally decreased between the sample taken at the end of the day and the first sample taken the following morning after the column had been allowed to sit overnight. Although the reaction kinetics were rapid, there was some slow diffusion of arsenic away from the surface when the fibers were allowed to sit in contact with the water for an extended period of time. Given the start-stop nature of point of use systems, this property further increases the operational life of the sorbents.

The table shown below (Table 5), summarizes the performance of each fiber sorbent column.

| | Mass of | | Approximate Arsenic |
|---|---|---|---|
| Sample | Column/g | BVs to 10 ppb | loading mg/g |
| Smopex ®-103 | 4.43 | 17,000 | 1.5 |
| Smopex ®-105 | 6.66 | 3,000 | 0.2 |
| DS-244 | 4.91 | 33,000 | 2.7 |

As a comparison, the performance of standard ArsenX^{np} beads (300 μm-1200 μm) (SolmeteX, Inc., Northborough Mass.) is included in FIG. 1. The ArsenX^{np} point of use experiment was performed on a larger scale using a bed size of about 0.21 gallons (about 0.8 L) and actual Northborough tap water adjusted to pH 6.5 with hydrochloric acid. The EBCT was similar (13.5 seconds) to the Smopex® columns.

As shown in FIG. 1, the performance (arsenic removal) using ArsenX^{np} beads was inferior to that using hydrous iron oxide impregnated Smopex®-103 and DS-244 fiber sorbents. Low levels of arsenic were detected in the effluent after only a couple of thousand bed volumes.

### EXAMPLE 3

Smopex® fibers for water treatment applications were processed into a form suitable for incorporation into a filter or cartridge. Processing was performed either before or after the fibers were modified or impregnated. Processing the fibers post-impregnation required heat-treating the fibers, which may affect the iron chemistry and subsequently the performance at sorbing arsenic from solution. To investigate this, a sample of Fe-impregnated DS-244 was heated at 100° C. to 110° C. for one hour and then re-evaluated for its ability to adsorb arsenic.

As shown in FIG. 2, arsenic breakthrough to 10 ppb decreased slightly to 29,000 BVs in the heated fibers, relative to the unheated fibers. Without being bound by a specific theory, the decrease in bed volumes to arsenic breakthrough may have been due to slight variations in arsenic content of the water (50 ppb±5 ppb) and uncertainty in the measured arsenic concentrations, because the 10 ppb limit was close to the detection limit of the ICP/AES, which was about 4 ppb. The mass of the column was 5.50 g, slightly greater than the 4.91 g of the column of the pre-heated material. Thus, heating did not destroy the ability of the sorbent to rapidly and selectively sorb arsenate from solution.

### EXAMPLE 4

Hydrated iron oxide impregnated DS-244 fibers were used to treat water containing 300 ppb arsenic. The column BV was 8 ml and the contact time was twelve seconds.

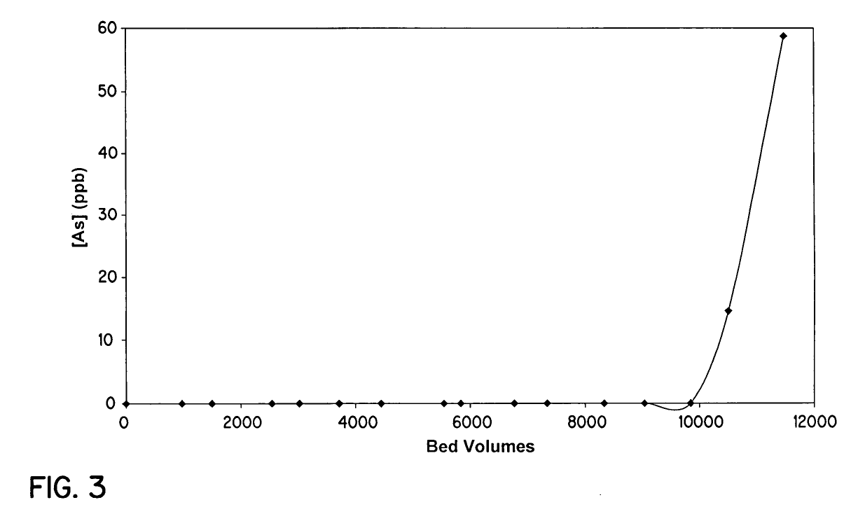

Results are shown in FIG. 3. Arsenic breakthrough occurred at about 10,000 BVs. These results indicate that the modified or impregnated fibers have a high arsenic capacity, even at very high flow rates, and readily remove very high concentrations of arsenic in the initial water to below the maximum contaminant limit (MCL) of 10 ppb. Under similar conditions, ArsenX^{np} beads showed almost immediate arsenic breakthrough above 10 ppb.

Among the fibers evaluated, DS-244 was readily impregnated, had the highest breakthrough capacity for arsenic, and had the lowest manganese content. The use of a polyacrylate material, relative to a polyolefin, was easier to wet and led to easier manufacturing and a more homogenous product.

Additionally, permanganate loaded onto an aliphatic quaternary ammonium group was more reactive than when loaded onto an aromatic pyridine-based equivalent group, which resulted in shorter processing times. Drying the Fe-impregnated DS-244 fibers had a limited impact on their performance.

Other methods to manufacture DS-244 fibers impregnated with hydrous iron oxide may use various volumes, reaction times, and concentrations of permanganate or other oxidants and iron, as known to one skilled in the art. For example, the lack of manganese in the final product indicated that the reaction was complete after five hours, so shorter reaction times may be determined by one skilled in the art. These methods may decrease processing costs due to a combination of reduced chemical consumption and reduced processing time.

Other variations or embodiments of the invention will also be apparent to one of ordinary skill in the art from the above description and examples. Thus, the forgoing embodiments are not to be construed as limiting the scope of this invention.

What is claimed is:

1. A sorbent for the selective removal of at least one contaminant from a fluid, said sorbent comprising a plurality of polymeric anion exchange fibers containing particles of a hydrated metal oxide substantially dispersed therein.

2. The sorbent of claim 1 wherein the fibers are impregnated with the hydrated metal oxide.

3. The sorbent of claim 2 wherein the hydrated metal oxide are nanoparticles.

4. The sorbent of claim 1 wherein the fibers are synthetic fibers for the recovery of metals from waste solutions and solutions from industrial and commercial processing.

5. The sorbent of claim 1 wherein the fibers have a polymeric backbone.

6. The sorbent of claim 1 wherein the fibers are selected from the group consisting of polyolefin, polyacrylic, polystyrene, viscose, and combinations thereof.

7. The fibers of claim 6 wherein the fibers contain a positively charged group capable of exhibiting anion exchange characteristics.

8. The sorbent of claim 7 wherein the fibers contain at least one of a quaternary amine group or a quaternary pyridinium group.

9. A method for selectively removing at least one contaminant from a fluid stream comprising contacting the fluid stream with a sorbent comprising a plurality of polymeric anion exchange fibers containing dispersed particles of a hydrated metal oxide for a time sufficient to provide a point of use or point of entry method of contaminant removal.

10. The method of claim 9 wherein the time does not exceed about 15 seconds.

11. The method of claim 9 wherein the contaminant is selected from the group consisting of arsenate, arsenite, dichromate, chromate, molybdate, selenite, uranium, vanadate, copper, zinc, antimony, tungsten, barium, radium, and combinations therefore.

12. A method of reducing at least one contaminant from a fluid stream, the method comprising
providing a hydrous metal oxide impregnated anion exchange fiber or fibrous sorbent,
contacting a portion of the sorbent with the fluid stream for less than about fifteen seconds, and thereafter
obtaining a treated fluid stream having a reduced contaminant level.

13. The method of claim 12 wherein said contaminant is selected from the group consisting of arsenate, arsenite, dichromate, chromate, molybdate, selenite, uranium, vanadate, copper, zinc, antimony, tungsten, barium, radium, and combinations therefore.

14. The method of claim 12 wherein the fluid stream is drinking water and contact occurs at a point of use or point of entry.

15. The method of claim 12 where the hydrous metal oxide is hydrous iron oxide or iron hydroxide particles.

16. A method for reducing contaminant levels in a fluid stream comprising contacting the fluid stream with a hydrous metal oxide impregnated anion-exchange fiber sorbent such that the rate of contaminant removal from the fluid stream exceeds the rate of contaminant removal when the fluid stream is in contact with a sorbent in granular or bead form.

17. A method for reducing contaminant levels in a fluid stream comprising providing an anion-exchange fiber sorbent, the sorbent containing at least one oxygen-containing compound of a redox-active metal, at a point of use such that the fluid stream is in contact with the sorbent for not greater than about fifteen seconds, thereby reducing contaminants in the fluid stream to render the water potable.

18. The method of claim 17 where the metal is a redox-active metal ion in an oxidation state below the maximum possible for the individual element.

19. The method of claim 17 wherein the metal is selected from the group consisting of Cu(I), Mn(II), V(III), Sn(II), Pt(II), Fe(II), Co(II) and Ru(II).

20. A method of polishing a fluid stream treated to reduce a level of at least one contaminant, the method comprising further contacting the fluid stream containing a reduced contaminant level with a sorbent comprising a plurality of polymeric anion exchange fibers containing dispersed particles of a hydrated metal oxide, to thereby polish the fluid stream.

21. The method of claim 20 wherein the fluid stream has a variable flow rate.

22. The method of claim 20 wherein the fluid stream is industrial effluent.

23. A filter to reduce a level of at least one contaminant in drinking water, the filter comprising a sorbent comprising a plurality of polymeric anion exchange fibers, the fibers modified to contain dispersed particles of a hydrated metal oxide, and a containment device for the fibers.

24. The filter of claim 23 wherein the modified fibers are incorporated in at least one of a filter mat, a spiral wound medium, a woven medium, a non-woven medium, and combinations thereof.

25. The filter of claim 23 associated with or integral with a drinking water container.

26. The filter of claim 23 associated with a household water purification system.

27. The filter of claim 23 associated with at least one water faucet.

28. The filter of claim 23 associated with a refrigerator water dispenser, a freezer ice dispenser, and combinations thereof.
